(19) United States
(12) Patent Application Publication
(10) Pub. No.: US 2007/0290554 A1
(43) Pub. Date: Dec. 20, 2007

(54) Vehicle control system

(75) Inventors: Kentarou Teshima, Kariya-city (JP); Kazuhiro Nakashima, Kariya-city (JP); Kenichi Ogino, Toyota-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/812,360

(22) Filed: Jun. 18, 2007

(30) Foreign Application Priority Data
Jun. 19, 2006 (JP) 2006-169119

(51) Int. Cl. B60L 1/00; E05F 15/00; B60N 2/02; H02G 3/00; B60R 22/00; B60N 2/00

(52) U.S. Cl. 307/10.1; 701/49; 296/64

(57) ABSTRACT

Portable devices are provided to occupants, who frequently use a vehicle. Based on a result of verification of an ID code of respective portable devices through intercommunication between the respective portable devices and a vehicle side unit, a number and a location of the occupant, who approaches the vehicle to get into a passenger compartment of the vehicle, are sensed. Based on the sensed result, a position of a seat, which is predicted to be used by the corresponding occupant, is changed.

### CROSS REFERENCE TO RELATED APPLICATION

This application is based on and incorporates herein by reference Japanese Patent Application No. 2006-169119 filed on Jun. 19, 2006.

### BACKGROUND OF THE INVENTION

1. Field of the Invention

The present invention relates to a vehicle control system, which changes a position of a seat to ease entry of an occupant into a passenger compartment of a vehicle.

2. Description of Related Art

Japanese Unexamined Patent Publication No. H10-211819 and Japanese Unexamined Patent Publication No. 2004-316231 recite systems which ease entry of an occupant into a passenger compartment of a vehicle. Specifically, in the system recited in Japanese Unexamined Patent Publication No. H10-211819, a remote control transmitter is provided. When a user operates a switch, which is provided on the remote control transmitter, slide doors, which are provided to a driver seat and a front passenger seat, respectively, can be opened and closed. In this way, when the occupant(s) gets into the passenger compartment of the vehicle, the door(s) can be opened and closed automatically. Thus, the entry of the occupant(s) into the passenger compartment is facilitated.

However, when both hands are full of, for example, baggage, it is difficult to operate the switch of the transmitter. In order to address this problem, the system of Japanese Unexamined Patent Publication No. 2004-316231 includes a smart entry key, a receiver and a control device. The smart entry key periodically transmits a radio signal, which includes an ID code signal. The receiver receives this radio signal outputted from the smart entry key. The control device opens a slide door of the vehicle when an impact is applied to a side sill of the vehicle upon reception of the radio signal. In this way, even in the ease where the hands are full of, for example, baggage, the slide door can be easily opened to facilitate the entry of the occupant into the passenger compartment of the vehicle.

However, each of the systems, which are recited in Japanese Unexamined Patent Publication No. H10-211819 and Japanese Unexamined Patent Publication No. 2004-316231, merely automatically opens the slide door in response to the operation of the switch and does not further facilitate the entry of the occupant into the passenger compartment. Here, it should be understood that a seat position also has a significant influence on the easiness of the entry of the occupant into the passenger compartment in addition to the opening and closing of the door.

For example, upon the opening of the door by the occupant, when a front space in front of the seat, which is located aside of the door, is narrow, it is often difficult to get into the seat or to move to another seat. Furthermore, generally, in a case of a vehicle, which has three rows of seats, when the occupant is trying to get into the seat in the third row, the occupant needs to move the seat in the second row toward the front side of the vehicle or to tilt a seat back of the seat in the second row. When this kind of work needs to be performed every time the occupant gets into the passenger compartment of the vehicle, the occupant may be annoyed.

### SUMMARY OF THE INVENTION

The present invention addresses the above disadvantage. Thus, it is an objective of the invention to provide a vehicle control system, which further facilitates entry of an occupant into a passenger compartment of a vehicle by changing a corresponding seat position.

To achieve the objective of the present invention, there is provided a vehicle control system, which includes a sensing means and a position changing means. The sensing means is for sensing a number and a location of at least one occupant, who approaches a vehicle to get into a passenger compartment of the vehicle. The position changing means is for changing a position of at least one predicted seat of the vehicle, on which the at least one occupant is predicted to be seated, to increase an available space for occupant entry based on a sensed result of the sensing means.

### BRIEF DESCRIPTION OF THE DRAWINGS

The invention, together with additional objectives, features and advantages thereof, will be best understood from the following description, the appended claims and the accompanying drawings in which:

FIG. 1 is a structural diagram showing an entire structure of a vehicle control system of an embodiment of the present invention;

FIG. 2 is a descriptive diagram for describing a seat position control device and a steering position control device of the vehicle control system;

FIG. 3 is a flowchart showing a control operation for unlocking respective doors and for changing a seat position(s) and/or a steering position based on a result of verification of an ID code through intercommunication between a vehicle side unit and a corresponding portable device in the vehicle control system;

FIGS. 4A and 4B are descriptive diagrams for describing ways of changing the seat position(s) and/or the steering position;

FIGS. 5A and 5B are descriptive diagrams for describing other ways of changing the seat position(s) and/or the steering position;

FIG. 6 is a flowchart showing a modification of the control operation of the vehicle control system; and

FIG. 7 is a flowchart showing another modification of the control operation of the vehicle control system.

### DETAILED DESCRIPTION OF THE INVENTION

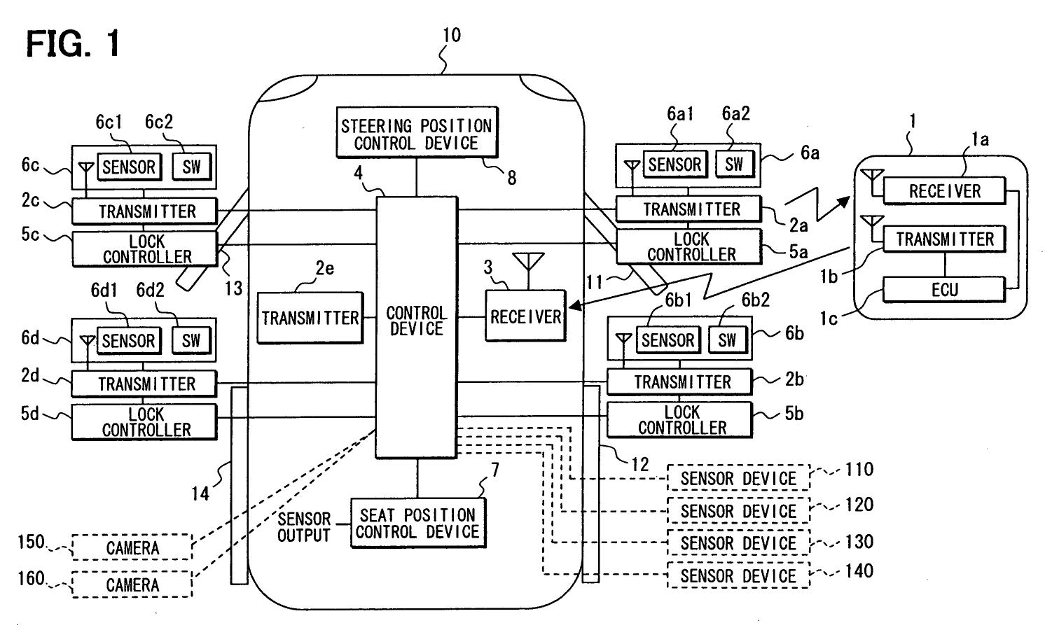

A vehicle control system according to an embodiment of the present invention will be described with reference to the accompanying drawings. FIG. 1 is a structural diagram showing an entire structure of the vehicle control system of the present embodiment.

The vehicle control system of the present embodiment controls locking and unlocking of each door 11-14 of a vehicle 10 based on a result of verification of an ID code of a portable device (an electronic key) 1, which is performed through intercommunication between the portable device 1 and a vehicle side unit installed in the vehicle 10. The vehicle side unit also controls a seat position and a steering wheel position in a passenger compartment to ease entry of a driver into the passenger compartment of the vehicle 10. In the present embodiment, the vehicle control system is implemented in the vehicle 10, which has three rows of seats. The vehicle 10 has front right and left swing doors 11, 13 for the front row (first row) of the seats (a driver seat and a front passenger seat) and right and left slide doors 12, 14 for the two rear rows (the second and third rows) of the seats.

As shown in FIG. 1, the portable device 1 includes a receiver la and a transmitter 1b. The receiver la of the portable device 1 receives a request signal from extravehicular transmitters 2a-2d or an intravehicular transmitter 2e. The transmitter 1b of the portable device 1 transmits a response signal, which includes the ID code of the portable device 1, in response to the request signal. An ECU 1c of the portable device 1 is connected to the receiver 1a and the transmitter 1b and executes various control processes. Specifically, the ECU 1c of the portable device 1 determines presence of the request signal based on the received signal of the receiver 1a. Furthermore, in response to the request signal, the ECU 1c of the portable device 1 generates the response single, which includes the ID code of the portable device 1, and transmits the response signal from the transmitter 1b.

The vehicle side unit includes the extravehicular transmitters 2a-2d, which are provided to the doors 11-14, respectively, of the vehicle 10. The vehicle side unit also includes the intravehicular transmitter 2e, which is provided in the passenger compartment. The extravehicular transmitters 2a-2d and the intravehicular transmitter 2e transmit the request signal based on a transmission command signal received from a control device 4 of the vehicle unit.

When the vehicle 10 is parked upon locking of each door 11-14, the request signal is transmitted from the extravehicular transmitters 2a-2d. A communication area is formed around each door 11-14 of the vehicle 10 based on a transmittable range of the request signal of the corresponding extravehicular transmitter 2a-2d. Thus, approaching of a carrier(s), who carries the portable device 1, to the corresponding door(s) 11-14 can be detected. Furthermore, a communication area of the intravehicular transmitter 2e is set to cover an interior space of the passenger compartment, so that it is possible to sense whether the portable device 1 is present in the passenger compartment. Alternatively, multiple intravehicular transmitters 2e may be provided such that a sum of communication areas of the multiple intravehicular transmitters 2e covers the entire interior space of the passenger compartment.

The vehicle side unit further includes a receiver 3, which is provided in the passenger compartment of the vehicle 10. The receiver 3 is placed in a response signal receivable state while being synchronized with outputting of the transmission command signal from the control device 4 to the transmitters 2a-2e. Thus, the receiver 3 can receive the response signal transmitted from the portable device 1. The response signal, which is received by the receiver 3, is outputted to the control device 4. The control device 4 verifies whether the ID code, which is included in the response signal, satisfies a predetermined relationship (e.g., matching of the ID code with a corresponding preregistered ID code). Then, based on the result of the verification, the control device 4 controls the locking and unlocking of the doors 11-14 and also controls the seat position and the steering wheel position to ease the entry of the occupant into the passenger compartment.

In the present embodiment, multiple portable devices 1 are provided, so that all of the vehicle occupants, who frequently use the vehicle 10, can carry the portable devices 1, respectively. In response to the request signal transmitted from the respective transmitters 2a-2e, each communicatable one of the multiple portable devices 1 replies the response signal, which includes the ID code that is specific to the portable device 1.

The vehicle side unit includes lock controllers 5a-5d, which are provided to the doors 11-14, respectively, of the vehicle 10 to lock and unlock the corresponding door 11-14. Specifically, each lock controller 5a-5d includes a door lock motor, which is rotated in a normal direction and a reverse direction to lock and unlock the corresponding door 11-14 in response to a lock signal and an unlock signal, respectively, which is transmitted from the control device 4.

Touch sensors 6a1-6d1 are provided to door handles 6a-6d, respectively, of the doors 11-14. Thus, when the carrier of the portable device 1 touches the door handle 6a-6d to operate the handle 6a-6d, such an operation can be detected through the corresponding touch sensor 6a1-6d1. When this operation of the door handle 6a-6d is detected, each door 11-14 is unlocked.

Furthermore, door lock switches 6a2-6d2, each of which is constructed as a push switch, are provided to the door handles 6a-6d, respectively. Each door 11-14 can be locked through operation of the corresponding door lock switch 6a2-6d2. Each door handle 6a-6d also functions as an antenna of the corresponding extravehicular transmitter 2a-2d.

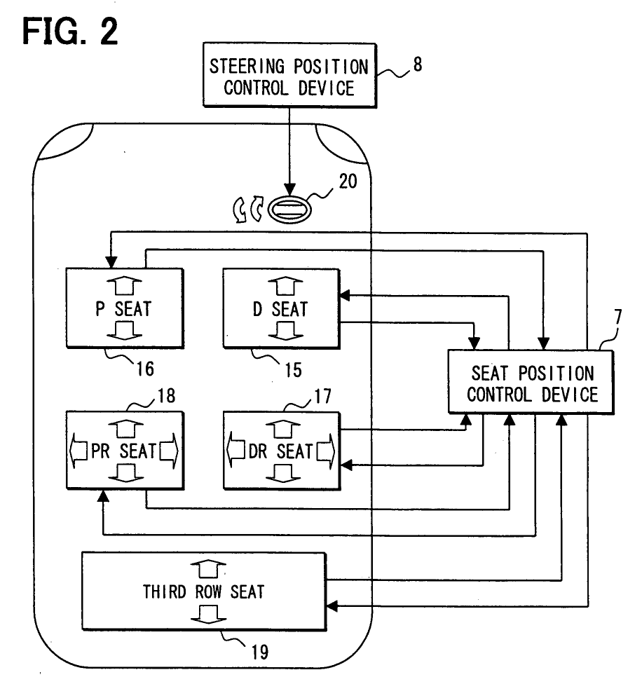

The vehicle side unit further includes a seat position control device 7, which controls the seat position(s), and a steering position control device 8, which controls the steering wheel position. The seat position control device 7 and the steering position control device 8 will be described in detail with reference to FIG. 2.

With reference to FIG. 2, the driver seat (D seat) 15 and the front passenger seat (P seat) 16 serve as the first row seats, and the position of the driver seat (D seat) 15 and the position of the front passenger seat (P seat) 16 can be changed in the front-to-rear direction of the vehicle 10 through use of a corresponding undepicted motor. The second row seats are sometimes referred to as captain seats and include a driver's rear seat (DR seat) 17 and a front passenger's rear seat (PR seat) 18, which are separated from each other. Each of the DR seat 17 and the PR seat 18 can be driven by an undepicted corresponding motor(s) to change its position in the front-to-rear direction of the vehicle 10 as well as in a left-to-right direction (a transverse direction) of the vehicle 10. Furthermore, the third row seat 19 is a bench seat, which is driven by an undepicted motor to change its position in the front-to-rear direction of the vehicle 10.

The structures of the above seats are only for illustrative purpose and may be changed in various ways. For example the D seat 15 and the P seat 16, which serve as the front row seats, may be modified to move in the transverse direction of the vehicle like the second row seats. Furthermore, with respect to the second row seats, another seat may be provided to a space between the DR seat 17 and the PR seat 18. Alternatively, a seat with a table function (i.e., a seat that can be transformed into a table) may be provided to the space between the DR seat 17 and the PR seat 18. When the seat with the table function is moved to a location between the front D seat 15 and the front P seat 16, this seat serves as a side table. In such a case, when the seat with the table function is moved to the location between the front D seat 15 and the front P seat 16, the DR seat 17 or the PR seat 18 may be moved in the transverse direction of the vehicle 10. Furthermore, with respect to the third row seat 19, the seat 19 may be divided into multiple seat sections, which can be independently moved in the front-to-rear direction. Alternatively, the present invention may be implemented in a vehicle, which does not have the third row seat(s), i.e., a vehicle, which has only the first and second row seats.

The seat position control device 7 receives a seat position change signal from the control device 4 and outputs a drive signal to the motor of each corresponding seat to change the position of the seat to a specified seat position, which is specified by the seat position change signal. The position of each seat is sensed through a corresponding sensor (not shown) and is supplied to the seat position control device 7. The seat position control device 7 stops the outputting of the drive signal when the sensed seat position coincides with the specified seat position. The seat position can be computed or predicted based on an output duration time period of the drive signal to the motor of each corresponding seat. Furthermore, the position of each seat can be adjusted to a desired seat position by its occupant through use of a corresponding operational switch (not shown), which is connected to the seat position control device 7.

Furthermore, each seat is provided with a seating sensor (not shown), which senses seating of the occupant on the seat, and a sensor signal of the seating sensor is supplied to the control device 4. The seating sensor may be in a form of a load sensor, which senses a load applied to a seat surface of the corresponding seat.

The steering position control device 8 outputs a drive signal to a motor, which changes a tilt angle of a steering wheel 20 to raise or lower the position (steering position) of the steering wheel 20. The steering position control device 8 receives a steering position change signal from the control device 4 and outputs the drive signal to the motor to adjust the steering position to a specified steering position, which is specified by the steering position change signal.

The position of the steering wheel 20 is sensed with a position sensor (not shown), and the sensed position of the steering wheel 20 is supplied to the steering position control device 8. In this way, the steering position control device 8 can move the steering wheel 20 to the specified steering position, which is specified from the control device 4. The tilt angle of the steering wheel 20 can be adjusted to a desired position by the occupant through use of an adjust switch (not shown), which is connected to the steering position control device 8.

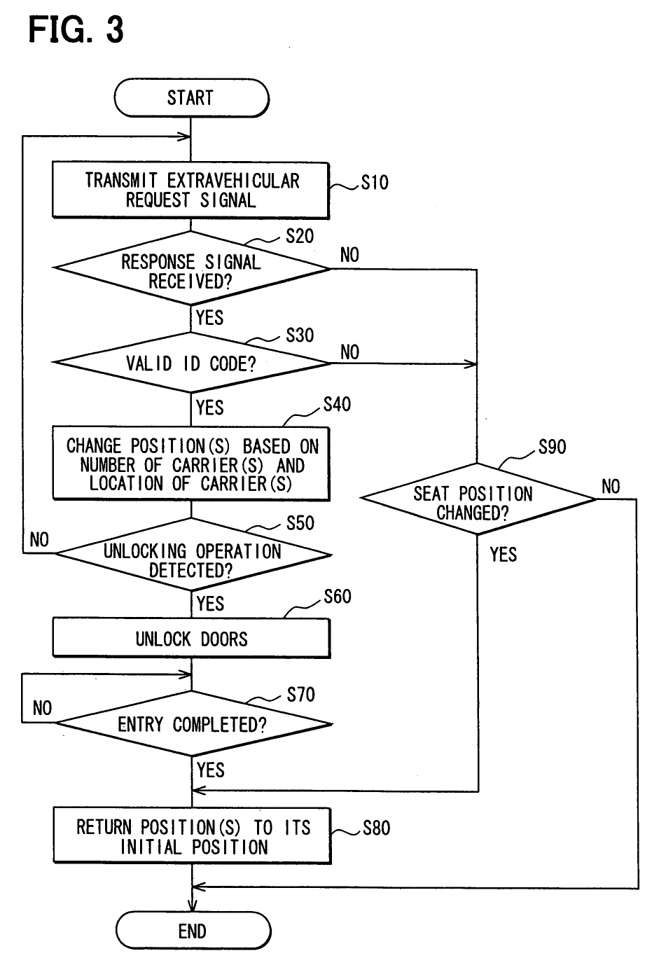

Next, a control operation of the control device 4 for unlocking the respective doors 11-14 and for changing the seat position(s) and the steering position based on the result of the verification of the ID code executed through the intercommunication between the vehicle side unit and each corresponding portable device 1 will be described with reference to a flowchart shown in FIG. 3. The operation of the flowchart of FIG. 3 is executed at predetermined intervals while each door 11-14 is locked in a parked state of the vehicle 10 upon turning off of the engine of the vehicle.

First, at step S10, the transmission command signal (extravehicular request signal) is outputted from the control device 4 to the extravehicular transmitters 2a-2d to output the request signal from the extravehicular transmitters 2a-2d. Then, at step S20, it is determined whether the response signal from each corresponding communicatable portable device 1, which responds to the request signal, is received. When it is determined that the response signal is not received at step S20, it is then determined that the communicatable portable device 1 is not present in the communication areas of the extravehicular transmitters 2a-2d. Thus, the operation proceeds to step S90. In contrast, when it is determined that the response signal is received from the corresponding portable device 1 at step S20, the operation proceeds to step S30.

Here, each extravehicular transmitter 2a-2d outputs the request signal, which includes a specific identification code that is specific or unique to the extravehicular transmitter 2a-2d. The portable device 1 replies the response signal that includes the identification code of the corresponding extravehicular transmitter 2a-2d, from which the request signal is received. Alternatively, the control device 4 may command the respective transmitters 2a-2d to sequentially transmit the request signal one after another. In this way, the control device 4 can determine which one of the request signals of the transmitters 2a-2d is responsible for the response signal replied from the portable device 1. That is, it is possible to identify one or more of the doors 11-14, toward which the carrier(s) of the portable device 1 is approaching.

At step S30, it is determined whether the ID code, which is included in the response signal, satisfies the predetermined relationship (e.g., matching of the ID code with the preregistered ID code) to verify the ID code. When it is determined that the ID code is valid through the verification of the ID code at step S30, the operation proceeds to step S40. In contrast, when it is determined that the ID code is invalid at step S30, the operation proceeds to step S90.

At step S40, the seat position(s) and/or steering position is changed based on the number and the location of the occupant(s) having the portable device 1 to ease the entry of the occupant(s) having the portable device 1 into the passenger compartment. In the present embodiment, as described above, the multiple portable devices 1 are provided to permit all of the vehicle occupants, who frequently use the vehicle 10, to carry his/her own portable device 1. Therefore, the number and the location of the occupant(s), who is going to enter the passenger compartment of the vehicle, can be identified based on the number of the valid portable device(s) 1 and the location(s) of the extravehicular transmitter(s) 2a-2d, to which the corresponding portable device(s) 1 responds.

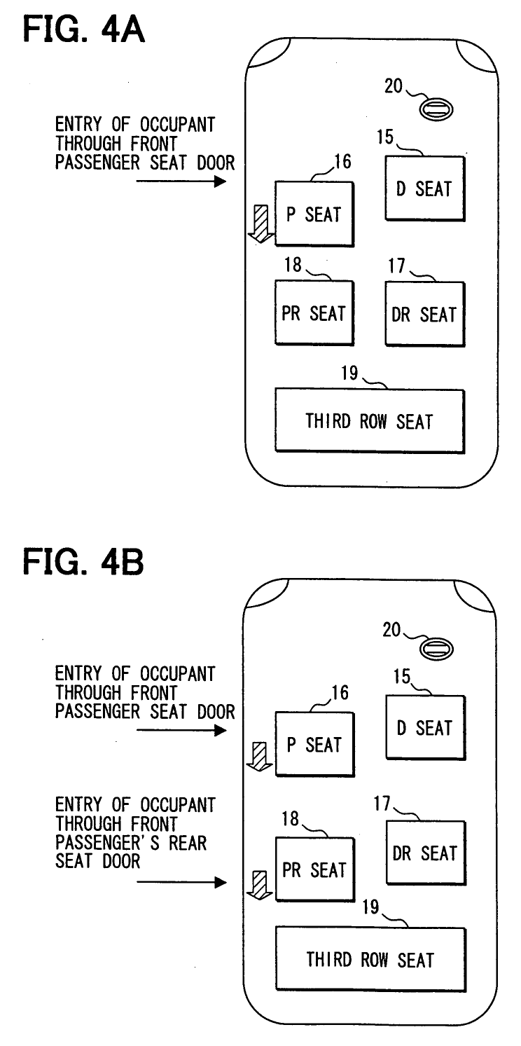

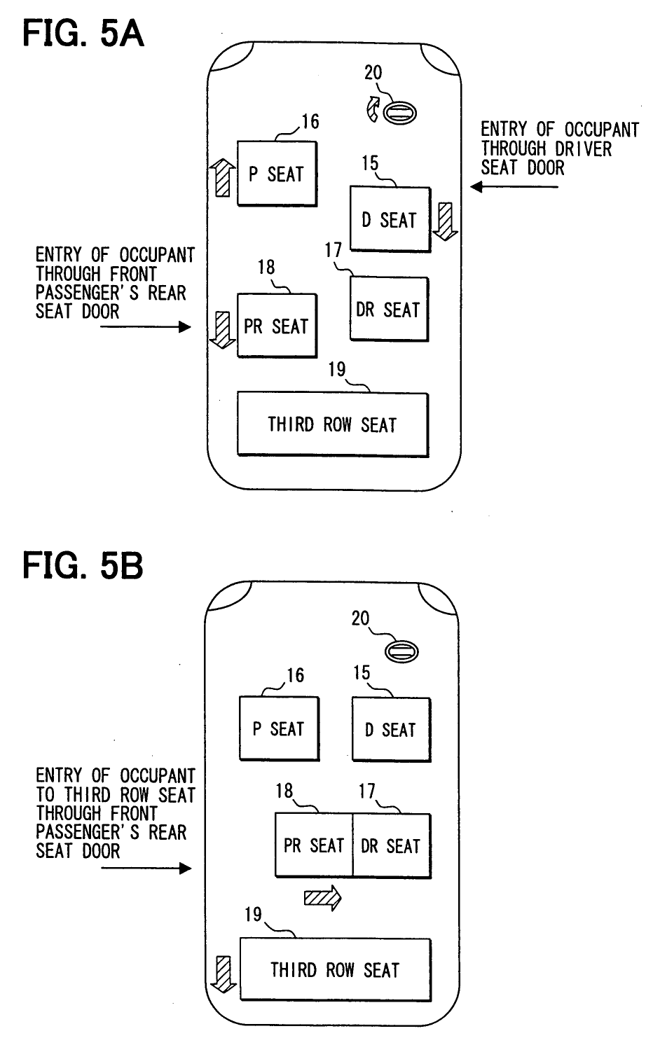

Exemplary cases for changing the seat position(s) and the steering position will be described with reference to FIGS. 4A to 5B. For example, with reference to FIG. 4A, when the occupant, who carries the portable device 1, approaches the left side front passenger seat door 13, it can be assumed that this occupant will get into the front passenger seat (P seat) 16 thorough the front passenger seat door 13. In such a case, the front passenger seat 16 is placed to a rear end position, as shown in FIG. 4A, to ease the entry of the passenger to the front passenger seat 16. In this way, the available space for the entry of the occupant to the front passenger seat 16 can be maximized.

In contrast, with reference to FIG. 4B, when the occupants, who carry the portable devices 1, respectively, approach the left front passenger seat door 13 and the front passenger's rear seat door 14, respectively, it can be assumed that these occupants will get into the front passenger seat 16 and the front passenger's rear seat (PR seat) 18, respectively, through the front passenger seat door 13 and the front passenger's rear seat door 14. In this case, when the front passenger seat 16 is placed to its rear end position, the occupant, who is trying to get into the front passenger's rear seat 18, may possibly have a difficulty in getting into the front passenger's rear seat 18. Thus, when it is assumed that the occupants, who are carrying the portable devices 1, respectively, are trying to get into the front passenger seat 16 and the front passenger's rear seat (PR seat) 18, respectively, the position of the front passenger seat 16 is set to a position that is spaced from the rear end position of the front passenger seat 16 on the front side of the rear end position of the front passenger seat 16, as shown in FIG. 4B. In this way, an appropriate entry space is provided to both of the occupants, who are trying to get into the front passenger seat 16 and the front passenger's rear seat 18, respectively, thereby allowing easy entry of these occupants.

Furthermore, with reference to FIG. 5A, when the occupant, who carries the portable device 1, approaches the driver seat door 11, it can be assumed that this occupant is trying to get into the driver seat (D seat) 15 through the driver seat door 11. In such a case, in order to ease the entry of the occupant into the driver seat 15, the driver seat 15 is moved to, for example, its rear end position, and the steering wheel 20 is moved or tilted in an upward direction of the vehicle. When the position of the driver seat 15 and the position of the steering wheel 20 are changed in the above described manner, the front space of the driver seat 15 is increased. Thus, the occupant can easily get into the driver seat 15.

Furthermore, there may be a case where no occupant is trying to get into the front passenger seat 16, and one occupant is trying to get into the front passenger's rear seat 18 through the front passenger's rear seat door 14. In such a case, with reference to FIG. 5A, the front passenger seat 16 is moved toward the front side of the vehicle (i.e., in the front direction of the vehicle), and the front passenger's rear seat 18 is moved toward the rear side of the vehicle (i.e., in the rear direction of the vehicle), for example, to the rear end position of the front passenger's rear seat 18. In this way, the maximum available space is provided to the occupant, who is trying to get into the front passenger's rear seat 18. Therefore, the occupant can easily get into the front passenger's rear seat 18.

Furthermore, through the intercommunication between the respective portable devices 1 and the vehicle side unit, when five or more occupants are detected or when approaching of two or more occupants to the driver's rear seat door 12 or the front passenger's rear seat door 14. is detected, it is assumed that at least one occupant will get into the third row seat 19. In such a case, in order to ease the entry of the occupant into the third row seat 19, one of the second row seats 17, 18, which is close to the driver's rear seat door 12 or the front passenger's rear seat door 14, toward which the occupants are approaching, is moved away from that door 12, 14 in the transverse direction of the vehicle. For example, in a case of FIG. 5B, the occupant, who is trying to get into the third row seat 19, is approaching the front passenger's rear seat door 14. Thus, the front passenger's rear seat 18 is moved toward the driver's rear seat 17 in the transverse direction of the vehicle.

Simultaneously with the movement of the above second row seat in the transverse direction of the vehicle, the third row seat 19 is moved toward the rear side of the vehicle, for example, to the rear end position of the third row seat 19. Through the above seat position adjustment, the entry of the occupant into the third row seat 19, which is most difficult among the front, second and third row seats, can be significantly eased.

At the time of changing each corresponding seat position described above, if each corresponding seat position is already in its appropriate position (its instructed position), the seat position will not be changed. Furthermore, in some cases, depending on the relationship between each corresponding seat position in the parked state of the vehicle and its instructed seat position, each corresponding seat may possibly be moved in an opposite direction, which is opposite from the direction indicated in the corresponding one of FIGS. 4A-5B.

In the present embodiment, when at least one carrier, who is carrying the portable device 1, is recognized, the touch sensor 6a1-6d1 of the corresponding door(s) 11-14, toward which the carrier is approaching, is activated to place the door(s) 11-14 in an unlock standby state. Then, at step S50, it is determined whether an unlock operation is performed, i.e., whether the carrier of the portable device 1 has grabbed the door handle 6a-6d of the corresponding door 11-14, which is placed in the unlock standby state.

Unless “YES” is returned at step S50, steps S10-S40 are repeated. Thus, even when the multiple occupants approach the corresponding doors 11-14 one after the other at different timing, the portable devices 1 of these occupants can be individually recognized.

When “YES” is returned at step S50, the operation proceeds to step S60. At step S60, each door 11-14 is unlocked. In this way, the occupant, who carries the portable device 1, can unlock and open the respective doors 11-14 of the vehicle. At the time of entering the passenger compartment, the position of the corresponding seat 11-14 has been changed in the above described manner. Thus, the occupant can easily enter the passenger compartment. Furthermore, according to the present embodiment, while the occupant, who carries the portable device 1, is located outside of the passenger compartment (i.e., before the entry of the occupant into the passenger compartment), the corresponding seat position(s) and/or steering position is changed. Therefore, for example, when the carrier of the portable device 1 gets into the passenger compartment, the corresponding seat position(s) and/or steering position have been already changed.

In the case where the above change in the seat position(s) and/or steering position is made, after completion of entry of the the occupant(s) into the passenger compartment, it is desirable that the seat position(s) and/or steering position is returned to its initial position. This is due to the fact that the seat position for facilitating the entry of the occupant into the passenger compartment and the seat position suitable for traveling of the vehicle differ from each other. Furthermore, after the completion of the entry of the occupant into the passenger compartment, the occupant should be seated on his/her seat, so that the seat position can be changed without any trouble.

At step S70, it is determined whether the entry of the occupant(s) into the passenger compartment is completed. At the time of making this determination, seating of at least the occupant into the driver seat 15 is sensed with, for example, a seating sensing switch, which is provided to each seat of the vehicle, and closure of all of the doors 11-14 is detected with, for example, courtesy lamp switches provided to the doors 11-14, respectively. Upon detection of them, it may be determined that entry of the occupant(s) into the passenger compartment is completed. Furthermore, detection of starting of the engine may be added to the above determination condition for determining the completion of the entry of the occupant into the passenger compartment. That is, when the starting of the engine is detected, it may be determined that the entry of the occupant into the passenger compartment is completed upon satisfaction of the above condition.

When it is determined that the entry of the occupant(s) into the passenger compartment is completed at step S70, the operation proceeds to step S80. At step S80, a signal is outputted to the seat position control device 7 and the steering position control device 8 to return the seat position(s) and/or steering position to its initial position. In this way, each seat position and the steering position are returned to its suitable position for the traveling of the vehicle.

As in the case of the present embodiment, when the seat position(s) and/or steering position is changed upon the presence of the the occupant, who carries the portable device 1, outside of the the passenger compartment, the seat position(s) and/or steering position may possibly be changed at the time of walking of the occupant, who carries the portable device 1, around the vehicle. In the case where the carrier of the portable device 1 does not initiate the entry into the passenger compartment, it is desirable that the changed seat position(s) is returned to its initial position without leaving the changed seat position(s). This is due to the fact that the desirable seat position(s) varies depending on the door, through which the occupant enters into the passenger compartment.

Therefore, at step S90, which is executed in the case where the response signal cannot be received from the portable device 1 or in the case where the result of the verification indicates the invalidity of the ID code, it is determined whether the seat position(s) is in the changed state. When “YES” is returned at step S90, the operation proceeds to step S80 where the seat position(s) and/or steering position is returned to its initial position.

That is, leaving of the carrier of the portable device 1 away from the vehicle is determined based on whether the response signal, which results in the validity of the ID code upon the verification of the ID code, is present. This is based on the fact that when the carrier of the portable device 1 is moving away from the vehicle, the intercommunication between the vehicle side unit and the portable device 1 becomes impossible, so that the response signal, which will result in the validity of the ID code upon the verification of the ID code, cannot be received any longer.

As described above, according to the present embodiment, the number and location(s) of the occupant(s), who is trying to get into the passenger compartment, is identified. Thus, even when the multiple occupants are trying to get into the passenger compartment, the corresponding seats can be placed into its appropriate position to ease the entry of each occupant.

The present invention is not limited to the above embodiment, and the above embodiment may be modified in various ways without departing from the spirit and scope of the invention.

For example, in the vehicle control system of the above embodiment, when the entry of the occupant(s) into the passenger compartment is completed, the seat position(s) and/or steering position is returned to its predetermined initial position. However, the appropriate seat position and/or steering position varies from person to person depending on his/her body size and preference. Thus, in the case where the seat position and/or steering position is adjusted by the occupant, the adjusted seat position and/or steering position may be stored as its initial position. In such a case, the seat position and/or steering position may be returned to the stored position thereof when it is determined that the entry of the occupant into the passenger compartment is completed. In this way, the seat position may be changed to the appropriate position, which matches with the body size and/or preference of the occupant.

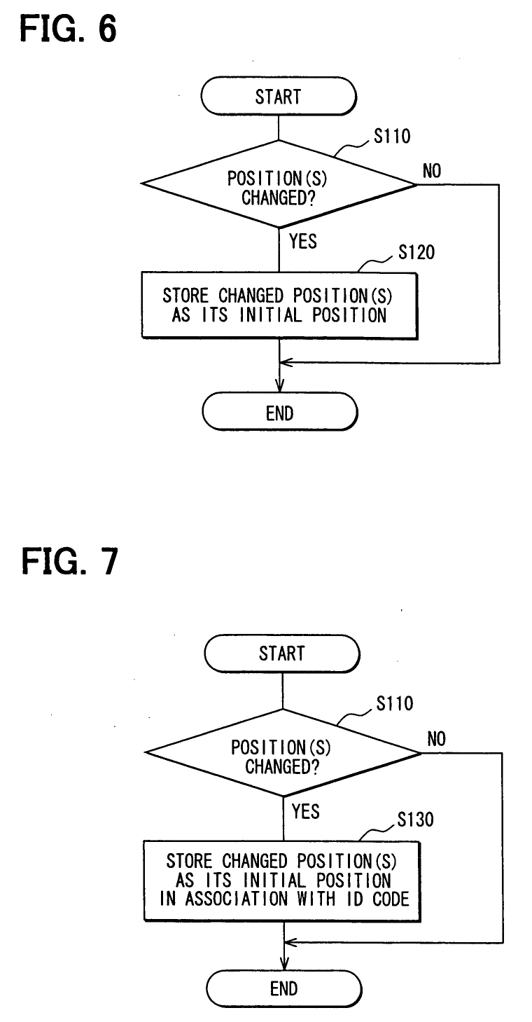

The adjusted seat position and/or steering position, which is adjusted by the occupant, may be stored as its initial position by executing an operation indicated by a flowchart in FIG. 6. With reference to the flowchart shown in FIG. 6, at step S110, it is determined whether the seat position and/or steering position has been changed by the occupant through use of a corresponding manipulation switch. When “YES” is returned at step S110, the operation proceeds to step S120. At step S120, the changed seat position and/or steering position is stored as its initial position.

Furthermore, when the occupant has changed the seat position and/or steering position through use of the corresponding operational switch, step S130 of FIG. 7 may be executed in place of step S120 of FIG. 6. Specifically, at step S130 of FIG. 7, the portable device 1, which is carried by the occupant who gets into the driver seat 15 through the driver seat door 11, is identified, and the changed seat position and/or steering position is stored as its initial position in association with the ID code of this particular portable device 1.

When the ID code of the portable device 1 coincides with the stored ID code, which is stored in association with the changed seat position and/or steering position, there is a high possibility of that the same occupant, who has previously changed the seat position and/or steering position, gets into the driver seat 15. Thus, when the changed (adjusted) seat position and/or steering position is stored as its initial position in association with the ID code, the seat position and/or steering position can be returned to its appropriate position, which is appropriate for the occupant, who actually gets into the driver seat 15.

Furthermore, in the above embodiment, each occupant, who often uses the vehicle, is provided with the portable device 1. The number and location(s) of the occupant(s), who is trying to get into the passenger compartment, is identified based on the result of the verification of each corresponding ID code through the intercommunication between the vehicle side unit and each corresponding portable device 1.

However, it is possible to use other measures to identify the number and location(s) of the occupant(s), who is trying to get into the passenger compartment. For example, each door 11-14 of the vehicle may be provided with an infrared sensor device 110-140 (see FIG. 1), which has a sensing area around the door 11-14. Each infrared sensor device 110-140 may be directly communicated with the control device 4. Alternatively, each infrared sensor device 110-140 may be indirectly communicated with the control device 4 through the corresponding extravehicular transmitter 2a-2d or the corresponding lock controller 5a-5d. The occupant, who is approaching the corresponding door, may be sensed with the infrared sensor device 110-140 provided to that door. For instance, when the sensed location of the occupant, which is sensed with the infrared sensor device, changes toward the vehicle door with time, it is possible to determine that the occupant is approaching that door. Also, in stead of constructing the sensor devices 110-140 as the infrared sensor devices, the sensor devices 110-140 may be any other suitable sensor devices (e.g., ultrasonic sensor devices or millimeter wave sensor devices), which use a light wave, a sound wave or a radio wave as its transmission media, may be used to sense the occupant(s), who is approaching the corresponding door(s) of the vehicle.

Furthermore, two cameras 150, 160 (see FIG. 1), which capture images at left and right sides, respectively, of the vehicle may be provided to capture an image of the occupant, who is approaching the door of the vehicle. The images, which are captured with the cameras, are processed through image processing by the control device 4 to detect the occupant(s), who is approaching the vehicle, thereby identifying the number and location(s) of the occupant(s).

Additional advantages and modifications will readily occur to those skilled in the art. The invention in its broader terms is therefore not limited to the specific details, representative apparatus, and illustrative examples shown and described.

What is claimed is:

1. A vehicle control system comprising:
a sensing means for sensing a number and a location of at least one occupant, who approaches a vehicle to get into a passenger compartment of the vehicle; and
a position changing means for changing a position of at least one predicted seat of the vehicle, on which the at least one occupant is predicted to be seated, to increase an available space for occupant entry based on a sensed result of the sensing means.

2. The vehicle control system according to claim 1, wherein when it is predicted that two or more occupants are included in the at least one occupant and are going to get into the passenger compartment through a first row seat door and a second row seat door, which are on the same side of the vehicle and correspond to a first row seat and a second row seat, respectively, based on the sensed result of the sensing means, the position changing means sets a seat position of the first row seat in a front side position, which is closer to a front side of the vehicle, in comparison to a case where it is predicted that only the first row seat door, which corresponds to the first row seat, is going to be used by the at least one occupant.

3. The vehicle control system according to claim 1, wherein:
first to third row seats are provided to the passenger compartment;
the position changing means determines whether the third row seat is going to be used by at least one of the at least one occupant based on the sensed result of the sensing means; and
when the position changing means determines that the third row seat is going to be used by the at least one of the at least one occupant, the position changing means moves the second row seat, which corresponds to a door that is predicted to be used by the at least one of the at least one occupant, in a transverse direction of the vehicle away from the door.

4. The vehicle control system according to claim 1, further comprising an entry completion determining means for determining whether entry of the at least one occupant into the passenger compartment is completed, wherein the position changing means returns each of the at least one predicted seat to a predetermined position thereof when the entry completion determining means determines that the entry of the at least one occupant into the passenger compartment is completed.

5. The vehicle control system according to claim 4, wherein:
the position changing means stores an adjusted position of at least one of the at least one predicted seat, which is adjusted by a corresponding one of the at least one occupant; and
the position changing means returns a current position of the at least one of the at least one predicted seat to the stored position, which serves as the predetermined position of the at least one of the at least one predicted seat, when the entry completion determining means determines that the entry of the at least one occupant into the passenger compartment is completed.

6. The vehicle control system according to claim 1, wherein when it is predicted that one of the at least one occupant is going to get into a driver seat through a driver seat door, which corresponds to the driver seat, the position changing means moves the driver seat in a rear direction of the vehicle and also moves a steering wheel of the vehicle in an upward direction of the vehicle.

7. The vehicle control system according to claim 6, further comprising an entry completion determining means for determining whether entry of the one of the at least one occupant to the driver seat is completed, wherein the position changing means returns each of the driver seat and the steering wheel to a predetermined position thereof when the entry completion determining means determines that the entry of the one of the at least one occupant to the driver seat is completed.

8. The vehicle control system according to claim 7, wherein:
the position changing means stores an adjusted position of the driver seat and an adjusted position of the steering wheel, which are adjusted by the one of the at least one occupant; and
the position changing means returns a current position of the driver seat and a current position of the steering wheel to the stored position of the driver seat and the stored position of the steering wheel, respectively, which serve as the predetermined position of the driver seat and the predetermined position of the steering wheel, respectively, when the entry completion determining means determines that the entry of the one of the at least one occupant to the driver seat is completed.

9. The vehicle control system according to claim 1, wherein:
the sensing means includes:
a plurality of portable devices, which are carriable by a plurality of occupants, respectively; and
a vehicle side unit, which is installed in the vehicle;
the vehicle side unit includes:
a plurality of transmitters, which are provided to a plurality of doors, respectively, of the vehicle to have a corresponding communication area around the door and which transmit a request signal to the plurality of portable devices;
a receiver that receives a response signal of each communicatable one of the plurality of portable devices, which replies the response single in response to the request signal; and
a verifying means for verifying whether a predetermined relationship exists between an ID code of the received response signal of each communicatable one of the plurality of portable devices and a corresponding registered ID code, which is preregistered, wherein:
each communicatable one of the plurality of portable devices transmits the response signal, which includes the ID code that is specific to the portable device, when the portable device receives the request signal; and
the sensing means senses the number and the location of the at least one occupant based on a location of each corresponding one of the plurality of transmitters that has transmitted the request signal to a corresponding verified one of the plurality of portable devices, which has the ID code that is verified by the verifying means.

10. The vehicle control system according to claim 1, wherein the sensing means includes a plurality of sensor devices, which are provided to a plurality of doors, respectively, of the vehicle and use one of a light wave, a sound wave and a radio wave as transmission media thereof to sense the at least one occupant.

11. The vehicle control system according to claim 1, wherein the sensing means includes:
a image capturing means for capturing an image of the at least one occupant, each of who approaches the vehicle toward a corresponding door of the vehicle; and
an identifying means for identifying the number and the location of the at least one occupant based on the captured image, which is captured with the image capturing means.
